(19) United States
(12) Patent Application Publication
(10) Pub. No.: US 2016/0146549 A1
(43) Pub. Date: May 26, 2016

(54) Heat Exchanger Element And Method of Production

(71) Applicant: Schunk Kohlenstofftechnik GmbH, Heuchelheim (DE)

(72) Inventors: Stefan Schneweis, Graevenwiesbach (DE); Volker Rauhut, Buseck (DE); Johannes Galle, Hundsangen (DE)

(21) Appl. No.: 14/945,493

(22) Filed: Nov. 19, 2015

(30) Foreign Application Priority Data
Nov. 21, 2014 (DE) 10 2014 223 779.3

(51) Int. Cl. F28F 3/00; B23P 15/26

(52) U.S. Cl. CPC F28F 3/00; B23P 15/26

(57) ABSTRACT

A method for producing a heat exchanger element for a heat exchanger, in particular for a recuperator or the like, and to a heat exchanger element, includes a substantially carbon body infiltrated with pyrolytic carbon. The heat exchanger element forms a first contact surface in a first flow channel of the heat exchanger and a second contact surface in a second flow channel of the heat exchanger.

### CROSS-REFERENCE TO RELATED APPLICATIONS

This application claims priority to German Patent Application No. 10 2014 223 779.3 filed on Nov. 21, 2015, which is fully incorporated herein by reference.

### STATEMENT REGARDING FEDERALLY SPONSORED RESEARCH OR DEVELOPMENT

Not applicable.

### FIELD OF THE INVENTION

The invention relates to a method for producing a heat exchanger element for a heat exchanger, in particular for a recuperator or the like, the heat exchanger element being made of a material consisting mainly of carbon, the heat exchanger element being realized in such a manner that the heat exchanger element forms a first contact surface in a first flow channel of the heat exchanger and a second contact surface in a second flow channel of the heat exchanger.

### BACKGROUND OF THE INVENTION

Heat exchangers allow an exchange of thermal energy from one fluid to another fluid, wherein the respective fluids or heat transfer media may be liquids, gases, gels, pasty media or the like. The heat exchanger is usually realized in such a manner that it separates the heat transfer media and exhibits good heat conduction so that a first heat transfer medium can transfer heat energy to a second heat transfer medium via the heat exchanger. To this end, a transfer of heat between a surface of the heat exchanger and the heat transfer media must by as a high as possible. In this context, plate heat exchangers or tube bundle heat exchangers are known, for example, in which plates or tubes form gaps that are alternately filled or flooded by heat transfer media. Consequently, a heat exchanger of the described kind forms at least two flow channels for heat transfer media, each flow channel having one contact surface.

In particular in the field of the chemical industry, heat exchangers are used that comprise heat exchanger elements that are substantially made of a graphite material. Only the heat exchanger element comes into contact with the respective heat transfer media and thus with the graphite material. The use of graphite for the heat exchanger element is disadvantageous because graphite is porous, which means that the respective heat transfer media may penetrate the graphite and potentially reach the adjacent flow channel. In the heat exchanger elements of this kind known from the state of the art, this problem is solved by impregnating the graphite with a resin material so as to close the pores present in the graphite. However, it has been shown that particles of such a resin impregnation are physically and/or chemically dissolved and may pollute the respective heat transfer medium. Also, corrosion on the graphite of the heat exchanger element and accompanying shedding of the graphite has been observed.

From DE 10 2010 030 780 A1, a heat exchanger element is known that is impregnated with resin or phenol resin but also has an additional coating on the respective contact surfaces of the flow channels. Said coating may consist of silicon carbide materials, carbide oxide materials, silicide materials or tungsten titanate materials. A coating of this kind is supposed to be robust and abrasion-resistant, preventing corrosion of the graphite of the heat exchanger element or shedding of resin.

However, a coating of this kind too has proven to have a number of disadvantages. In particular, the coating is susceptible to surface damage, which may re-expose the infiltrated resin or the graphite. Surface damage may be easily inflicted on the contact surfaces during handling of the heat exchanger element, such as during production or installation of the heat exchanger, without becoming immediately apparent. Furthermore, the coating may easily crack in case of thermal stress so that the heat transfer medium may penetrate the coating. This substantially limits the range of use of a heat exchanger of this kind. In particular in case of a resin-infiltrated heat exchanger element, a coating can only be applied at very low process temperatures because otherwise the resin carbonates, which is undesirable. Also, this limits the range of use of resin-infiltrated heat exchangers to a maximum of 250° C.

### SUMMARY OF THE INVENTION

Therefore, the object of the present invention is to propose a method for producing a heat exchanger element, a heat exchanger element and a heat exchanger by means of which leakage of substances in the area of the flow channels may be prevented. This object is attained by a method, a heat exchanger element, and a heat exchanger described herein.

In the method described herein for producing a heat exchanger element for a heat exchanger, in particular for a recuperator or the like, the heat exchanger element is made from a material consisting mainly of carbon, the heat exchanger element being realized in such manner that the heat exchanger element forms a first contact surface in a first flow channel of a first heat transfer medium of the heat exchanger and a second contact surface in a second flow channel of a second heat transfer medium of the heat exchanger, wherein the heat exchanger element or the contact surfaces is/are infiltrated with pyrolytic carbon.

The heat exchanger element described herein is initially made entirely from the material consisting mainly of carbon in such a manner that the heat exchanger element is a body consisting of the material. The body has a porous structure due to the production process and a homogenous alignment of the crystal structure of the material. Thus, a surface of the body is porous, which enlarges the respective contact surface overall. Because of the porous structure, the respective heat transfer media may penetrate the material of the heat exchanger element. Since the heat exchanger element is infiltrated with pyrolytic carbon, the pyrolytic carbon or the pyrolytic graphite may penetrate the pores of the body of the heat exchanger element and substantially completely fill the pores. The pyrolytic carbon can then also penetrate the body of the heat exchanger element only to a certain depth so that the pores in the area of the respective contact surfaces are closed or sealed.

By infiltration of the heat exchanger element with pyrolytic carbon, the surface of the body of the heat exchanger element that is exposed to the respective heat exchanger media is substantially reduced and thus has improved mechanical and chemical resistance. Infiltration of the heat exchanger element with a resin, such as known from the state of the art, is no longer necessary. The pores filled with the pyrolytic carbon thus form a diffusion barrier against the heat transfer media and their ingredients. Consequently, the heat transfer media cannot intermix and potential pollution of the heat transfer media by the material of the body of the heat exchanger element is substantially reduced. Also, it is no longer necessary to provide the contact surfaces of the flow channels with an additional surface coating. This leads to a substantially longer service life of the heat exchanger element, wherein the heat exchanger element may now also be used in temperature ranges higher than 650° C., in particular in a range of 1000° C. to 1200° C., and even 1700° C. depending on the medium.

The heat exchanger element may be made entirely of carbon and preferably of graphite. The heat exchanger may be formed by an assembly of a plurality of heat exchanger elements or also by one heat exchanger element alone.

Advantageously, the graphite of the body of the heat exchanger element may have a density of <2 g/cm³, preferably of 1.7 g to 1.9 g/cm³. The graphite may then have an open-pored structure, which can be easily infiltrated with the pyrolytic carbon. In particular, the pyrolytic carbon can readily penetrate the graphite body.

When infiltrating the heat exchanger element, pores in the graphite of the heat exchanger element can then be closed or filled by the pyrolytic carbon. Filling of the pores alone may form a diffusion barrier and increase corrosion resistance.

When infiltrating the heat exchanger element with the pyrolytic carbon, an infiltration layer may also be formed. In that case, the pyrolytic carbon penetrates the body of the heat exchanger element only to a certain depth so that the infiltration layer is formed within the body.

In the method, the infiltration layer within the body may be formed at a temperature of 500° C. to 1900° C., preferably of 600° C. to below 1700° C. Thus, it is possible to also carry out the infiltration with pyrolytic carbon at comparatively low temperatures, making the method simple and cost-effective. Preferably, the heat exchanger element may be infiltrated by means of a CVI process (chemical vapor infiltration).

In one embodiment of the invention, it may be provided that the heat exchanger element is coated with a surface layer of pyrolytic carbon. Accordingly, a surface of the body or the contact surfaces of the flow channels of the heat exchanger element may be provided with an additional surface layer that is applied to the surface and that covers and closes the pores and the graphite of the body of the heat exchanger element. It is also particularly advantageous that the coating then consists of pyrolytic carbon or of pyrolytic graphite because it is substantially the same material as the material of the body of the heat exchanger material and as the material used for infiltration. Also, compared to graphite, for example, pyrolytic carbon in particular exhibits a different degree of crystallization and a lower rate of oxidation and etching, resulting on its own in improved corrosion resistance of the thus formed contact surfaces.

Preferably, the heat exchanger element may then be coated by means of a CVD process (chemical vapor deposition). In that case, the body of the heat exchanger element cannot only be infiltrated but also superficially coated. For example, it may be envisaged that first a CVI process and subsequently the CVD process is performed.

It may also be envisaged that during a process duration of an infiltration and coating of the body of the heat exchanger element, infiltration is performed at a first temperature within a first process stage and subsequently the coating is applied at a second temperature within a second process stage, wherein the first process stage may be selected longer than the second process stage and/or the first temperature may be selected lower than the second temperature. In this way, it is possible, for example, to first infiltrate the body of the heat exchanger element with pyrolytic carbon, wherein infiltration can then advantageously take place during a comparatively long process period at a low process temperature. An outer coating of a surface or of the contact surfaces of the body of the heat exchanger element can be applied subsequently by increasing the process temperature to the second temperature level. The thus performed second process stage at the increased process temperature can then run comparatively shorter. For example, infiltration including a subsequent surface coating with pyrolytic carbon could easily take place in this way within one uninterrupted coating process.

Moreover, thermal after-treatment after infiltration or application of a coating, such as annealing, graphitization and the like, may be omitted. A further treatment step of the heat exchanger element, which may also exceed a selected process temperature, is no longer required.

The heat exchanger element described herein for a heat exchanger, in particular for a recuperator or the like, is made of a material consisting mainly of carbon, the heat exchanger element forming a first contact surface in a first flow channel of a first heat transfer medium of the heat exchanger and a second contact surface in a second flow channel of a second heat transfer medium of the heat exchanger, wherein the heat exchanger element or the contact surfaces are infiltrated with pyrolytic carbon. With respect to the advantages of a heat exchanger element realized in this manner, reference is made to the description of the advantages of the method according to the invention.

The heat exchanger element as well as the heat exchanger may be realized as one piece or in multiple parts. This means that a body of the heat exchanger element made of carbon or graphite, for example, may be realized as one piece, while the heat exchanger may also be composed of multiple bodies that are made of graphite and that may be put together to form a heat exchanger. The substantial aspect is that the heat exchanger element or the body of the heat exchanger element is not merely a formed layer or coating of a molded body, but a three-dimensional geometrical object or molded body.

The heat exchanger element may be realized in such a manner that a surface of the heat exchanger element is completely infiltrated. Alternatively, only the contact surfaces of the heat exchanger element may be infiltrated that may come into contact with the respective heat transfer media. Surface areas of the heat exchanger element that do not come into contact with a heat transfer medium do not necessarily have to be infiltrated. A method for infiltrating the heat exchanger element can thus be optionally simplified.

Furthermore, an infiltration layer of the heat exchanger element may be realized with a layer thickness of up to 100 μm, preferably of up to 500 μm, and particularly preferably of up to 2500 p.m. The infiltration layer then refers to a layer that is formed below a surface or below the contact surface of the body of the heat exchanger element and within the body. In this case, it is also possible to form a diffusion barrier even with a comparatively thin infiltration layer and to achieve a distinctly improved corrosion resistance of the body of the heat exchanger element. In principle, however, it is advantageous to arrive at an infiltration layer that reaches as deep as possible into the body.

An infiltration layer of the heat exchanger element may have a porosity of <1%, preferably <0.1%, and particularly preferably of 0%. Having a porosity of substantially 0%, the infiltration layer can be especially gas-tight, i.e. form a highly effective diffusion barrier.

A surface layer of the heat exchanger element may be realized with a layer thickness of 1 μm to 500 μm, preferably of 5 μm to 100 μm, and particularly preferably of 5 μm to 50 μm. A surface layer then relates to a layer or coating that is applied to a surface or contact surface of a body of the heat exchanger element, wherein a distinct effect with respect to realizing improved corrosion resistance may be achieved with a surface layer as thin as 5 μm. Thus, it is not necessary to apply thicker surface layers to the respective heat exchanger element. Advantageously, the surface layer of the coating of the heat exchanger element or of the body of the heat exchanger element may be made of anisotropic carbon because this may further improve corrosion resistance. A service life of the heat exchanger element or of a heat exchanger may thus be substantially increased.

The heat exchanger element may be realized monolithically and form a heat exchanger block for a block heat exchanger, a heat exchanger plate for a plate heat exchanger or a heat exchanger tube for a tube heat exchanger.

### BRIEF DESCRIPTION OF THE DRAWINGS

In the following paragraphs, preferred embodiments of the invention will be explained in more detail with reference to the accompanying drawing.

In the figures:

FIG. 1 shows a first embodiment of a heat exchanger in a top view;

FIG. 2 shows a second embodiment of a heat exchanger in a top view;

FIG. 3 shows a third embodiment of a heat exchanger in a perspective view;

FIG. 4 shows a sectional view of an infiltration layer;

FIG. 5 shows a diagrammatic illustration of an infiltration process; and

FIG. 6 shows a sectional view of another infiltration layer.

### DETAILED DESCRIPTION OF THE EXAMPLE EMBODIMENTS

FIG. 1 shows a heat exchanger 10 that is formed by a cylindrical, monolithic body 11 of a heat exchanger element 12. In the roll-shaped body 11, passage bores 13 are formed in the longitudinal direction of the body 11 and passage bores 14 are formed in the transverse direction of the body 11. The passage bores 13 and 14 each form flow channels 15 and 16, respectively, for heat transfer media (not illustrated). Consequently, contact surfaces 17 and 18, respectively, come into contact with the respective heat transfer medium in the flow channels 15 and 16, heat energy being transferred from one heat transfer medium to the other heat transfer medium via the body 11 made from graphite. The body 11 is infiltrated with pyrolytic carbon. The pyrolytic carbon has not completely penetrated the body 11 so that infiltration layers 20, 21 and 22, respectively, are formed below each of the contact surfaces 17 and 18 and below an outer surface 19.

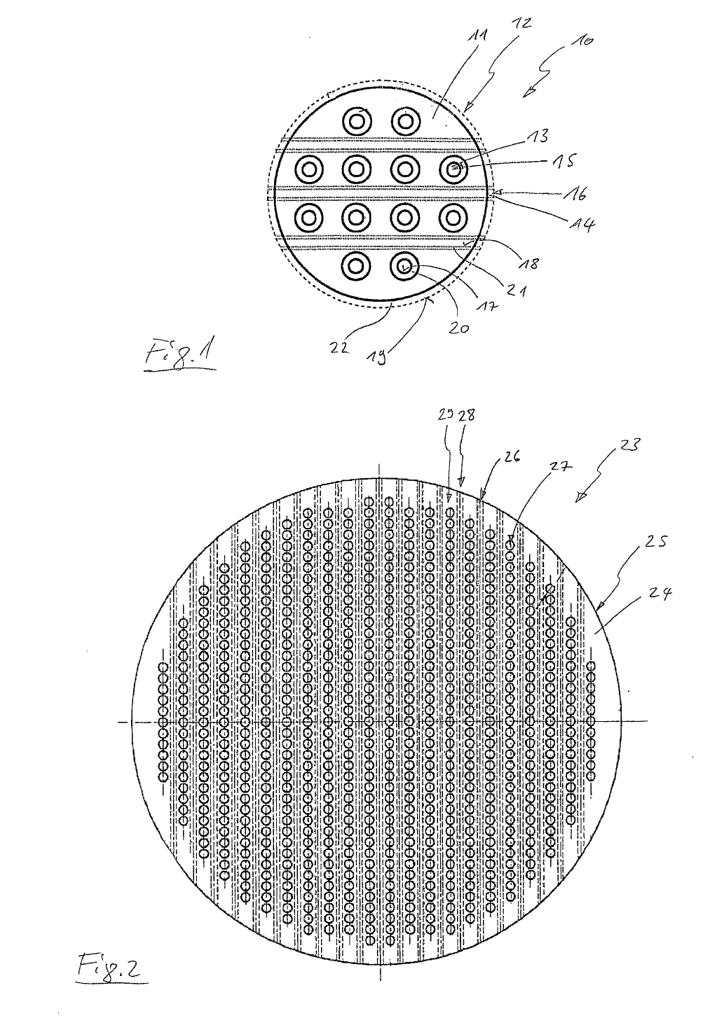

FIG. 2 shows another embodiment of a heat exchanger 23, which is, in principle, realized in the same way as the heat exchanger illustrated in FIG. 1. The heat exchanger 23 also has a plurality of flow channels 26 that are realized in the longitudinal direction of a body 24 of a monolithic heat exchanger element 25, flow passages 27 running transverse to the longitudinal direction of the body 25 being arranged in such a manner that the flow passages 26 and 27 form layers 28 and 29, respectively, whose fluids intersect. The body 24 and the flow channels 26 and 27 are completely infiltrated with pyrolytic carbon.

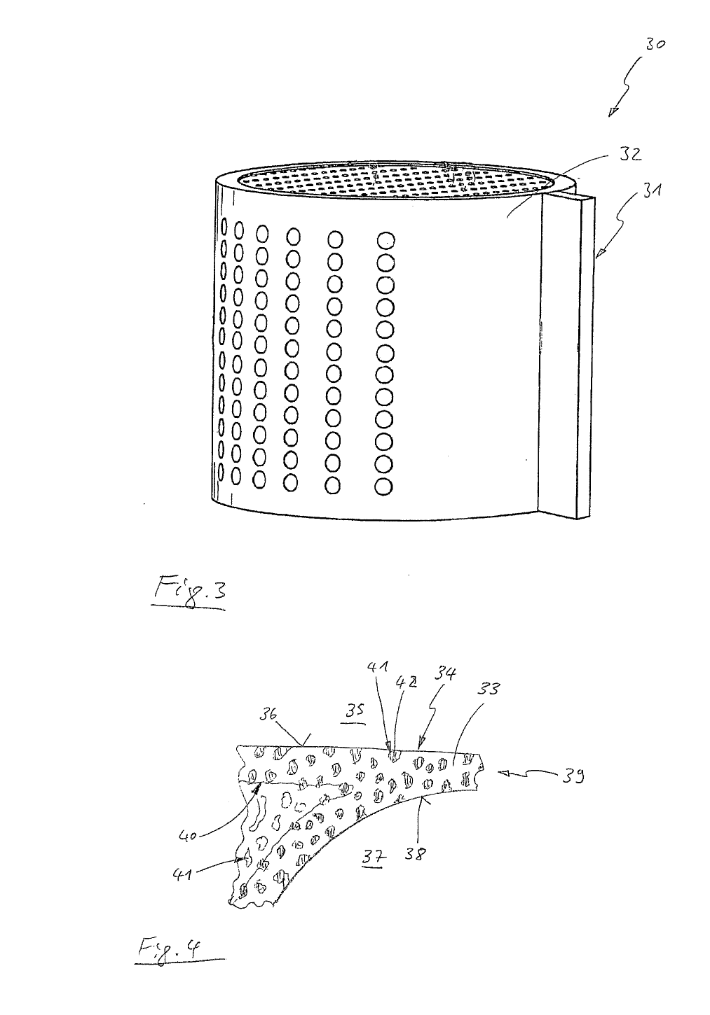

The embodiment of a heat exchanger 30 shown in FIG. 3 comprises a heat exchanger element 31 consisting of a one-piece body 32. The heat exchanger element 31 is substantially realized in the same way as the afore-described heat exchanger elements and is infiltrated with pyrolytic carbon.

FIG. 4 shows an enlarged view of an infiltration layer 33 of a heat exchanger element 34, which is illustrated only in part, in a sectional view. The heat exchanger element 34 forms a first flow channel 35 having a first contact surface 36 and a second flow channel 37 having a second contact surface 38, the flow channels 35 and 37 being separated by a wall 39 of the heat exchanger elements 34. The heat exchanger element 34 is made of graphite and is infiltrated with pyrolytic carbon, so that the infiltration layer 33 is formed up to a layer depth 40. The graphite or the heat exchanger element 34 has a plurality of pores 41, which may be interconnected and would allow heat transfer media to diffuse into the heat exchanger element 34. In the area of the infiltration layer 40, the pores 41 are infiltrated and substantially completely filled with pyrolytic carbon 42. The pores 41 in the area of the contact surfaces 36 and 38 are thus completely closed.

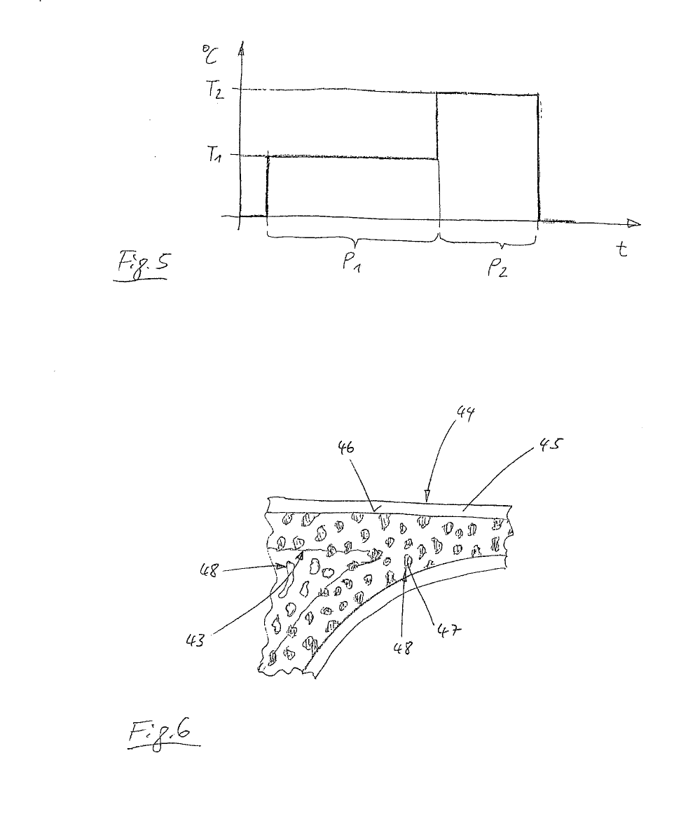

FIG. 5 shows a diagram of a process for coating a heat exchanger element. During a process duration t of the coating process of the heat exchanger element or of a body of the heat exchanger element, the temperature T1 in a first process stage P1 is 600° C., for example, a second process stage P2 taking place after the first process stage P1, during which a second temperature T2 of 1700° C. is used, for example. During the first process stage P1, an infiltration layer is formed, a surface layer being formed during the second process stage P2. A CVI process or a CVD process is envisaged as a coating process.

FIG. 6 shows another sectional illustration of an infiltration layer 43 in an enlarged view. In contrast to the infiltration layer shown in FIG. 4, the heat exchanger element 44 in this case has a surface layer 45 that has been applied to the heat exchanger element 44. The surface layer 45 is made from pyrolytic carbon and has a porosity of substantially 0%. The surface layer 45 covers in particular a graphite surface 46 and pores 48 of the infiltration layer 43 that are filled with pyrolytic carbon 47.

1. A method for producing a heat exchanger element for a heat exchanger, the heat exchanger element having a body being made from a material consisting mainly of carbon, the heat exchanger element being realized in such a manner that the heat exchanger element forms a first contact surface in a first flow channel of the heat exchanger and a second contact surface in a second flow channel of the heat exchanger, said method comprising:
infiltrating the heat exchanger element with pyrolytic carbon.

2. The method according to claim 1, in which the heat exchanger element is made from graphite.

3. The method according to claim 2, in which the graphite has a density of <2 g/cm³.

4. The method according to claim 2, in which when infiltrating the heat exchanger element, pores in the graphite of the heat exchanger element are closed or filled with the pyrolytic carbon.

5. The method according to claim 1, in which an infiltration layer is formed when infiltrating the heat exchanger element with the pyrolytic carbon.

6. The method according to claim 5, in which the infiltration layer is formed at a temperature of between about 500° C. to 1900° C.

7. The method according to claim 1, in which the heat exchanger element is infiltrated using a CVI process.

8. The method according to claim 1, in which the heat exchanger element is coated with a surface layer of pyrolytic carbon.

9. The method according to claim 8, in which the heat exchanger element is coated using a CVD process.

10. The method according to claim 8, in which, the infiltration is performed at a first temperature (T1) within a first process stage (P1) and subsequently the coating is applied at a second temperature (T2) within a second process stage (P2), the first process stage being selected longer than the second process stage and/or the first temperature being selected lower than the second temperature.

11. A heat exchanger element for a heat exchanger, said heat exchanger element comprising:
a body consisting mainly of carbon infiltrated with pyrolytic carbon, the heat exchanger element forming a first contact surface in a first flow channel of the heat exchanger and a second contact surface in a second flow channel of the heat exchanger.

12. The heat exchanger element according to claim 11, in which a surface of the heat exchanger element is completely infiltrated.

13. The heat exchanger element according to claim 11, in which an infiltration layer of the heat exchanger element has a layer thickness of at least 100 μm.

14. The heat exchanger element according to claim 11, in which an infiltration layer of the heat exchanger element has a porosity of less than 1%.

15. The heat exchanger element according to claim 11, in which a surface layer of the heat exchanger element has a layer thickness of between about 1 μm to 500 μm.

16. The heat exchanger element according to claim 11, in which the heat exchanger element is monolithic and forms a heat exchanger block, a heat exchanger plate or a heat exchanger tube.

17. A heat exchanger comprising a heat exchanger element according to claim 11.
